(19) United States
(12) Patent Application Publication
(10) Pub. No.: US 2026/0219882 A1
(43) Pub. Date: Jul. 30, 2026

(54) POLYMORPHIC SYSTEM LEVEL CACHE HAVING LOCAL VECTOR PROCESSING

(71) Applicant: QUALCOMM Incorporated, San Diego, CA (US)

(72) Inventors: Mahdi NAZM BOJNORDI, San Diego, CA (US); Paul Nicholas WHATMOUGH, Cambridge, MA (US)

(21) Appl. No.: 19/039,686

(22) Filed: Jan. 28, 2025

(51) Int. Cl. G06F 9/30; G06F 7/57

(52) U.S. Cl. CPC G06F 9/30047; G06F 7/57; G06F 9/30036; G06F 9/30189

(57) ABSTRACT

Techniques described herein include a polymorphic system level cache. The polymorphic system level cache includes a cache controller and plurality of banks. The cache controller is configured to control operation of each of the plurality of banks. At least one bank of the plurality of banks includes: a data array; a local register communicatively coupled to data array; and an arithmetic logic unit array communicatively coupled to the local register and the data array.

Aspects of the present disclosure generally relate to system level cache and, more particularly, to a polymorphic system level cache that, in addition to a traditional cache operation mode, may be configured in a non-cache operation mode to allow one or more banks of cache memory to be directly accessed (e.g., bypassing tag checking) and function as a buffer to provide for improved (e. g, faster) data transfer between, for example, two processing units.

### BACKGROUND

System-on-chips may include processing units (e.g., central processing unit, neural processing unit, graphics processing unit, etc.). System-on-chips may also include a system level cache that is shared by the processing units. For example, the system level cache may include cache memory that is partitioned into multiple banks to allow for multiple processing units to simultaneously access the system level cache. The system level cache reduces the number of times the processing units have to access a main memory that is separate (e.g., off-chip) from the system-on-chips. In this manner, by reducing the number of times the processing units access the main memory, the system level cache reduces latency and power consumption associated with accessing the main memory.

### BRIEF SUMMARY

In one aspect, an apparatus is provided. The apparatus typically includes: a system level cache comprising a cache controller and plurality of banks, the cache controller configured to control operation of each of the plurality of banks, at least one bank of the plurality of banks comprising: a data array; a local register communicatively coupled to data array; and an arithmetic logic unit array communicatively coupled to the local register and the data array.

In another aspect, a method performed by a system level cache included in a system-on-chip, comprising: receiving a request to access the system level cache, the request including an address range corresponding to an address range for a respective bank of a plurality of banks of the system level cache; determining a non-cache operation mode as a selected operation mode for the respective bank of the plurality of banks; and accessing the respective bank of the system level cache according to the selected operation mode, wherein the accessing comprises performing one or more vector operations using an arithmetic logic unit array that is included in the respective bank of the system level cache.

In yet another aspect, an apparatus is provided. The apparatus typically includes: means for receiving a request to access a system level cache, the request including an address range corresponding to an address range for a respective bank of a plurality of banks of the system level cache; means for determining a non-cache operation mode as a selected operation mode for the respective bank of the plurality of banks; and means for accessing the respective bank of the system level cache according to the selected operation mode, wherein the accessing comprises performing one or more vector operations using an arithmetic logic unit array that is included in the respective bank of the system level cache.

The following description and the related drawings set forth in detail certain illustrative features of one or more aspects.

### BRIEF DESCRIPTION OF THE DRAWINGS

The appended figures depict certain features of one or more aspects of the present disclosure and are therefore not to be considered limiting of the scope of this disclosure.

FIG. 1 depicts a block diagram of a system-on-chip according to some aspects of the present disclosure.

FIG. 2 depicts a block diagram of a system level cache included in a system-on-chip according to some aspects of the present disclosure.

FIG. 3 depicts a block diagram of a data array included in a system level cache according to some aspects of the present disclosure.

FIG. 4 depicts a block diagram of a polymorphic system level cache according to some aspects of the present disclosure.

FIG. 5 depicts a block diagram of a register for a cache controller of a polymorphic system level cache according to some aspects of the present disclosure.

FIG. 6 depicts a block diagram of a bank of cache memory having a local register for temporary storage of data associated with an operation performed on a cache line of data array included in the bank of cache memory according to some aspects of the present disclosure.

FIG. 7 depicts a block diagram of a bank of cache memory having an arithmetic logic unit array for local vector processing according to some aspects of the present disclosure.

FIG. 8 depicts a flowchart of a method for operating a polymorphic system level cache according to some aspects of the present disclosure.

FIG. 9 depicts a flowchart of a method for vector processing according to some aspects of the present disclosure.

FIG. 10 depicts an example processing system in which the polymorphic system level cache of FIG. 4 may be included according to various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide a polymorphic system level cache.

Conventional system level cache that is typically used in a system-on-chip follows a tag/data access process and, as a result, cannot ensure data persistence in on-chip memory during a data transfer between, for example, two different processing units of the system-on-chip. Consequently, data transfers between the different processing units of the system-on-chip involve using a main memory that is separate (e.g., off-chip) from the system-on-chip. Using the main memory for such data transfers introduces inefficiencies (e.g., latency and power consumption) associated with operation of the system-on-chip.

Furthermore, conventional system-on-chips typically include arithmetic logic unit arrays that are included in the individual processing units (e.g., central processing unit, graphics processing unit, neural processing unit, etc.) of system-on-chips. As a result, data operations, such as vector operations, performed on data stored in cache memory of the system level cache for conventional system-on-chips are performed by the arithmetic logic unit arrays included in one of the processing units. The latency associated with requesting vector operations on data stored in the cache memory of the system level cache can be significant, especially for computationally-intensive workloads (e.g., associated with executing machine learning algorithms).

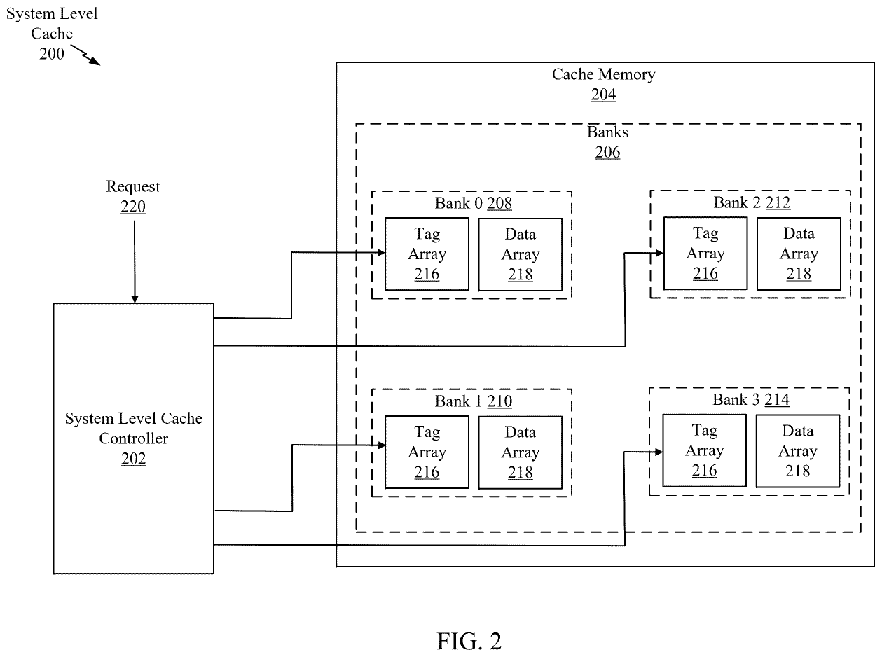

Example aspects of the present disclosure are directed to a polymorphic system level cache that is configurable in at least two different operations mode, such as a cache operation mode and a non-cache operation mode. In the cache operation mode, the system level cache performs a tag checking process associated with a tag/data access process that is performed by conventional system level caches and is discussed below in more detail with reference to FIG. 2. In the non-cache operation, the polymorphic system level cache bypasses the tag checking process associated with the tag data/access process and, in doing so, allows banks of cache memory included in the polymorphic system level cache to be accessed directly. In this manner, by configuring the polymorphic system level cache in the non-cache operation mode, the polymorphic system level cache can be configured to provide improved (e.g., faster) data transfer between, for example, two different processing units of a system-on-chip.

Furthermore, the polymorphic system level cache according to the present disclosure may include a local register to temporarily store data associated with operations performed on data stored in a respective bank of the cache memory (e.g., while the respective bank of the cache memory is configured in the non-cache operation). Furthermore, the polymorphic system level cache may include an arithmetic logic unit array (e.g., one or more arithmetic logic units) located in proximity (e.g., next) to the local register and configured to perform different vector operations. In this manner, by including an arithmetic logit unit array in the cache memory, the polymorphic system level cache of the present disclosure eliminates (or at least reduces) the latency associated with performing vector operations on data stored in system level cache as compared to traditional system level caches.

### Example System-on-Chip

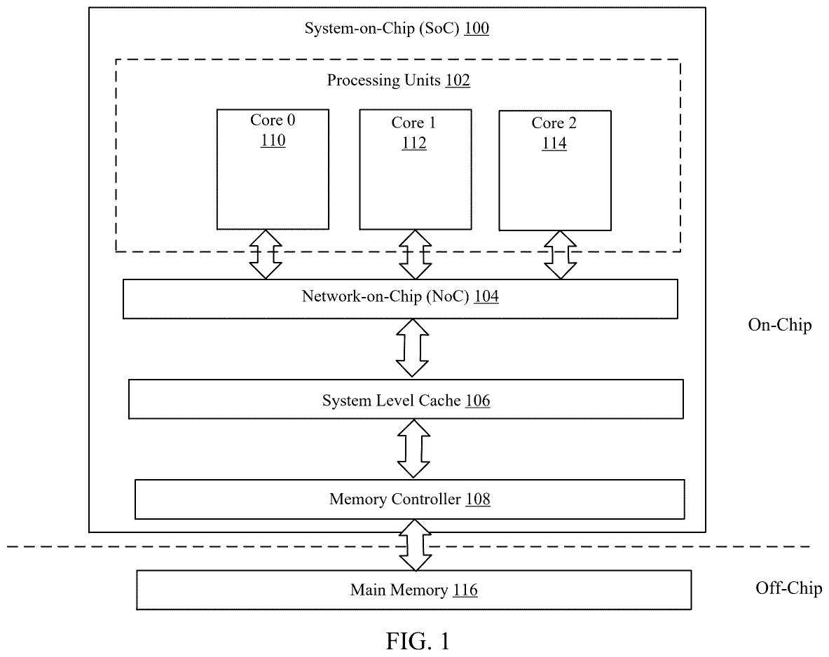

FIG. 1 depicts a system-on-chip 100 according to some aspects of the present disclosure. The system-on-chip 100 may include a plurality of processing units 102, a network-on-chip (NoC) 104, a system level cache 106, and a memory controller 108.

As illustrated, the plurality of processing units 102 may include a first processing unit 110 (e.g., labeled as “Core 0”), a second processing unit 112 (e.g., labeled as “Core 1”), and a third processing unit 114 (e. g, labeled as “Core 2”). In some aspects, the first processing unit 110 may be a central processing unit (CPU), the second processing unit 112 may be a neural processing unit (NPU), and the third processing unit 114 may be a graphics processing unit (GPU). It should be understood that, in other aspects, the system-on-chip 100 may include more or fewer processing units 102 than shown in FIG. 1.

The NoC 104 may include a communication subsystem that interconnects the various components within the system-on-chip 100 For instance, the NoC 104 may provide a communication network that allows the different components (e.g., processing units 102, system level cache 106) of the system-on-chip 100 to exchange data and control signals.

The system level cache 106 may be a shared cache memory that is accessible by each of the plurality of processing units 102. By providing a shared cache memory, the system level cache 106 may improve the overall performance of the system-on-chip 100. For instance, the system level cache 106 may reduce latency and increase bandwidth for data accesses, because the plurality of processing units 102 can access commonly used data from the system level cache 106.

The memory controller 108 may be configured to manage communications between the system level cache 106 and a main memory 116 that is separate (e. g, off-chip) from the system-on-chip 100. For instance, if one of the plurality of processing units 102 requests data that is not already stored in the system level cache 106, the system level cache 106 (e.g., a cache controller thereof) may notify the memory controller 108 that a cache miss has occurred.

Based on the notification of the cache miss for the requested data, the memory controller 108 may generate a memory access request to fetch the requested data from the main memory 116. Upon fetching the requested data from the main memory 118, the memory controller 108 may allocate a new cache line in the system level cache 106 to store the requested data.

In some aspects, the system level cache 106 may need to evict an existing cache line to make room for the new cache line. This is known as a cache line replacement, and the evicted cache line may be written back to the main memory 118. Once the requested data is available in the system level cache 106, the system level cache 106 can respond to the processing unit that requested the data.

### Example Architecture for System Level Cache

FIG. 2 depicts a system level cache 200 according to some aspects of the present disclosure. For instance, the system level cache 200 may be implemented in the system-on-chip 100 discussed above with reference to FIG. 1.

The system level cache 200 may include a cache controller 202 and cache memory 204. As illustrated, the cache memory 204 may be partitioned into a plurality of banks 206 to allow parallel access to different banks simultaneously. In this manner, the bandwidth and throughput of the system level cache 200 may be improved.

In some aspects, the cache memory 204 may be partitioned into a first bank 208 (e.g., labeled “Bank 0”), a second bank 210 (e.g., labeled “Bank 1”), a third bank 212 (e.g., labeled “Bank 2”), and a fourth bank 214 (e.g., labeled “Bank 3”). In other aspects, the cache memory 204 may be partitioned into more or fewer banks.

In some aspects, each of the plurality of banks 206 of the cache memory 204 may include a tag array 216 and a data array 218. Each respective tag array 216 may be configured to store address tags that correspond to the cache lines stored in the respective data array 218. For instance, the tag array 216 included in the first bank 208 of the cache memory 204 may store address tags that correspond to the cache lines stored in the data array 218 included in the first bank 208 of the cache memory 204.

When the cache controller 202 receives a request 220 for data, the cache controller 202 is configured to perform a cache lookup. In some aspects, the cache lookup may include checking the tag arrays 216 to determine if the requested data is stored in the cache memory 204. If one of the tag arrays 216 returns a cache hit (that is, an address included in the request 220 matches one of the stored address tags), then the cache controller 202 may access the corresponding cache line in the respective data array 218 to retrieve the requested data.

If, however, each of the tag arrays 216 returns a cache miss (that is, the address included in the request 220 does not match one of the stored address tags), then, as previously with reference to the discussion of FIG. 1, the cache controller 202 requests (e.g., via the memory controller 108 of FIG. 1) the data from main memory (e.g., main memory 116 in FIG. 1).

### Example Data Array

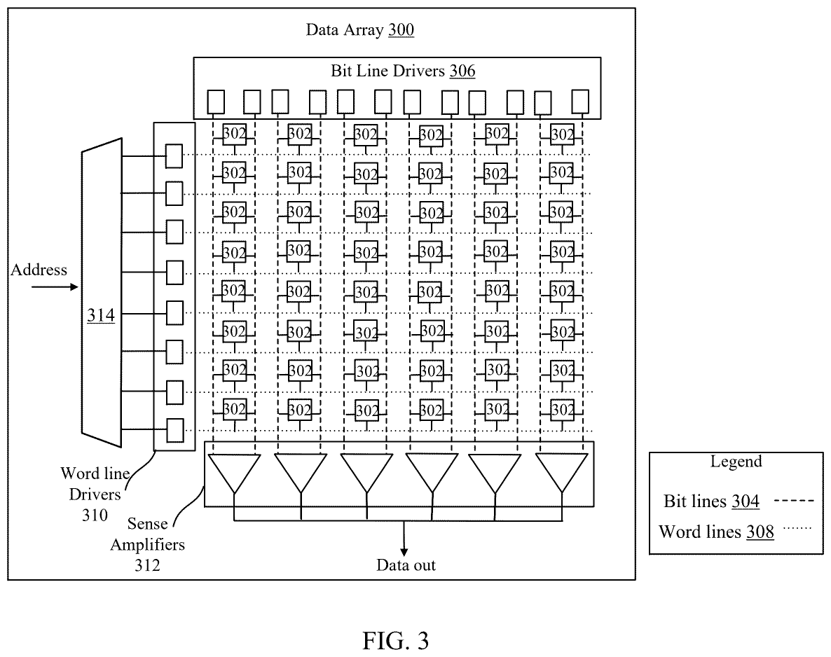

FIG. 3 depicts an example data array 300 according to some aspects of the present disclosure. For instance, the data array 300 may be included in the cache memory 204 of the system level cache 200 discussed above with reference to FIG. 2.

In some aspects, the data array 300 may include a plurality of memory cells 302, a plurality of bit lines 304, a plurality of bit line drivers 306, a plurality of word lines 308, a plurality of word line drivers 310, a plurality of sense amplifier 312, and an address demultiplexer 314.

In some aspects, the memory cells 302 may be arranged in a row-column configuration. For example, the memory cells 302 may be arranged as 8 rows and 6 columns. The memory cells 302 in each column are coupled to two respective bit lines of the plurality of bit lines 304. Furthermore, the memory cells 302 in each row are coupled to a respective word line of the plurality of word lines 308.

In some aspects, an address demultiplexer 314 may receive an address (e.g., typically a combination of row and column addresses) from the cache controller (e.g., the cache controller 202 of FIG. 2). The address demultiplexer 314 may separate the address into a row address (e.g., corresponding to one of the rows of memory cells 302) and a column address (e.g., corresponding to one of the columns of memory cells 302). In some aspects, the address demultiplexer 314 may output the row and column addresses separately to the appropriate circuits (e.g., bit line drivers 306, word line driver 310) of the data array 300. In this manner, the appropriate bit lines 304 (e.g., two bit lines associated with the column in which the memory cell to be accessed is included) and word line 308 may be selected to access a particular memory cell of the plurality of memory cells 302. For instance, the particular memory cell may be accessed to perform a read operation in which data stored on the particular memory cell is read or a write information in which data is written to the particular memory cell.

Each respective sense amplifier of the plurality of sense amplifiers 312 may be connected to a respective pair of bit lines 304 that is connected to memory cells 302 included in a respective column of the plurality of columns of memory cells 302. The respective pair of bit lines may include a true bit line and a complement bit line. The true bit line may carry a true (or normal) logic level of data being read from (or written to) a respective memory cell of the memory cells 302 connected to the true bit line, whereas the complement bit line may carry the complement (or inverted) logic level of the data

When the respective memory cell is accessed during a memory operation (e. g, read operation or write operation), the sense amplifier 312 connected to the respective pair of bit lines 304 (that is, the true bit line and the complement bit line) may sense a voltage difference (e.g., in the range of millivolts or smaller) between the true bit line and the complement bit line. The sense amplifier 312 may amplify the voltage difference to a full logic level (e.g., low or high) that can be reliably interpreted. In some aspects, the sense amplifier 312 outputs a signal indicative of a state (e.g., 0 or 1) of the respective memory cell accessed during a read operation.

In some aspects, each of the memory cells 302 may be a static random access memory (SRAM) cell. For instance, the SRAM cell may include 6 transistors and therefore may be referred to as 6T SRAM cells. The six transistors may include two pull-up transistors and two pull-down transistors that collectively form two cross-coupled inverters responsible for storing a state (e.g., logic 1 or logic 0) of the SRAM cell. The six transistors may also include two access transistors that connect the SRAM cell to two bit lines 304 of the data array 300. More specifically, the source and drain terminals of the two access transistors connect to two bit lines 304 corresponding to the column in which the SRAM cell is located. Additionally, the gate terminal of the two access transistors is connected to the word line 308 corresponding to the row in which the SRAM cell is located.

### Example Polymorphic System Level Cache

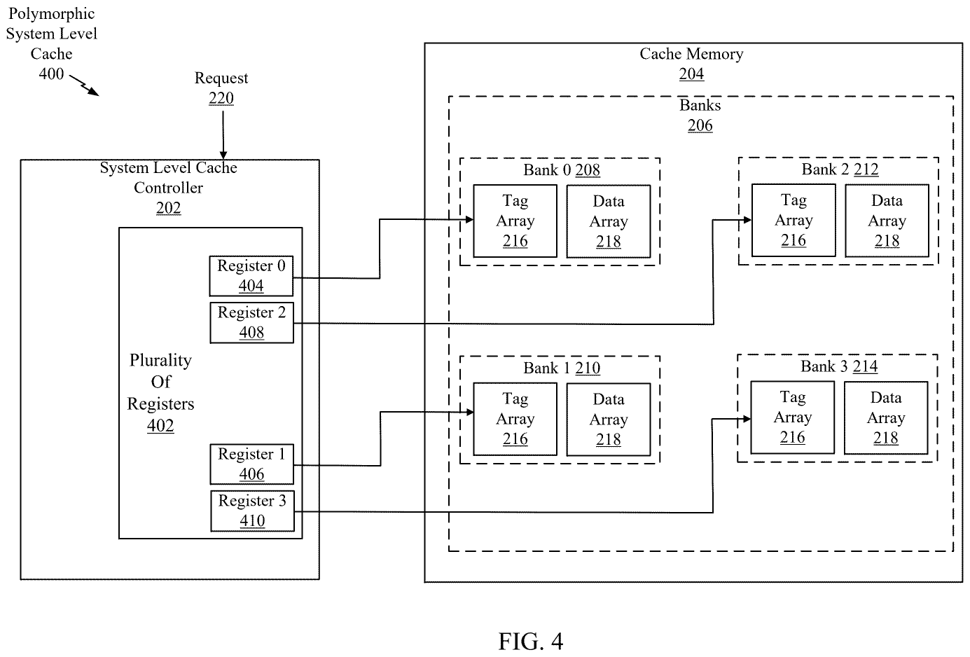

FIG. 4 depicts a polymorphic system level cache 400 according to some aspects of the present disclosure. The polymorphic system level cache 400 may include the same components as the system level cache 200 discussed above with reference to FIG. 2. Accordingly, the same reference numbers may be used for those components the polymorphic system level cache 400 shares with the system level cache 200 of FIG. 2.

The polymorphic system level cache 400 may also include additional components (e.g., not included in the system level cache 200 of FIG. 2) that allow the polymorphic system level cache 400 to be configurable in a cache operation mode (e.g., in which the system level cache 200 operates at all times) and a non-cache operation mode. In this manner, the polymorphic system level cache 400 may, in contrast to the system level cache 200 of FIG. 2, be configurable in the non-cache operation mode to bypass the tag checking process discussed above with reference to FIG. 2. And, by operating in the non-cache operation mode and bypassing the tag checking process, the cache memory 204 (or at least a portion (e.g., bank) thereof) of the polymorphic system level cache 400 may be directly accessed (e. g, bypassing the tag arrays 216) to facilitate faster data transfer between, for example, two processing units (e.g., the processing units 102 of FIG. 1) of a system-on-chip (e.g., the system-on-chip 100 of FIG. 1) on which the polymorphic system level cache 400 is implemented. In this manner, the non-cache operation provided by the polymorphic system level cache 400 may be advantageous for computationally intensive workloads involving multiple processing units, such as machine learning algorithms, that call for fast data transfer between processing units (e.g., CPU and NPU) than provided by conventional system level caches, such as the system level cache 200 of FIG. 2.

In some aspects, the cache controller 202 of the polymorphic system level cache 400 may include a plurality of registers 402. Each of the registers 402 may correspond to a respective bank of the plurality of banks 206 of the cache memory 204. For instance, the plurality of registers 402 may include a first register 404 (e.g., labeled “Register 0”) communicatively coupled to the first bank 208 of the cache memory 204, a second register 406 (e.g., labeled “Register 1”) communicatively coupled to the second bank 210 of the cache memory 204, a third register 408 (e.g., labeled “Register 2”) communicatively coupled to the third bank 212 of the cache memory 204, and a fourth register 410 (e.g., labeled “Register 3”) communicatively coupled to the fourth bank 214 of the cache memory 204.

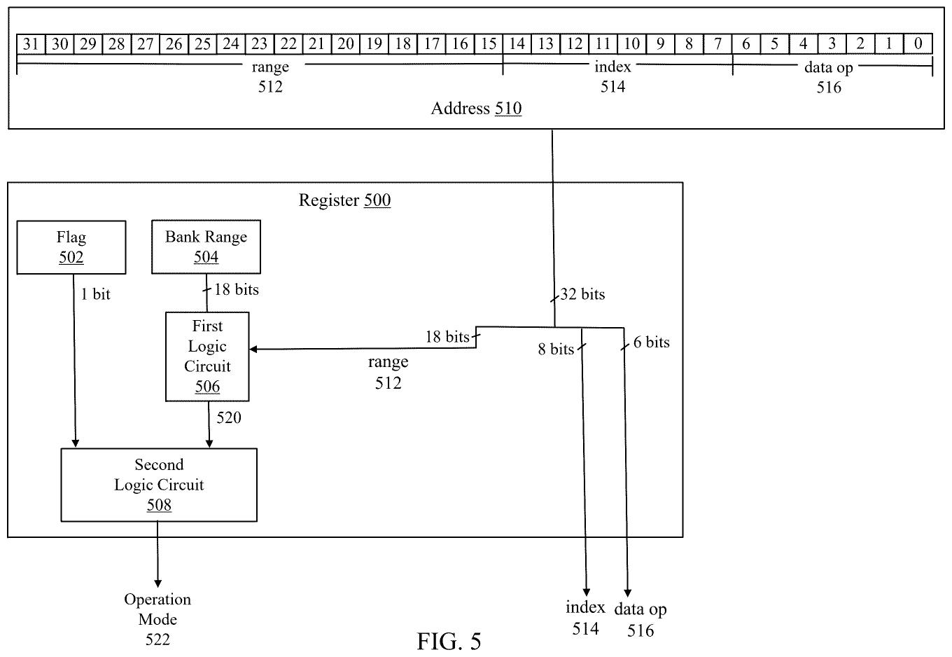

As will be discussed in more detail with reference to FIG. 5, each of the plurality of registers 402 may be programmed (e.g., via software) to dynamically configure an operation mode (e.g., the cache operation mode or the non-cache operation mode) for a respective bank of the cache memory 204. In some aspects, each respective register of the plurality of registers 402 may be programmed to configure the corresponding bank of the cache memory 204 in the non-cache operation mode. In alternative aspects, only a portion of the cache memory 204 may be configured in the non-cache operation mode. For example, the first register 404 may be programmed to configure the first bank 208 of the cache memory 204 in the non-operation mode, whereas each remaining register (e.g., second register 406, third register 408, and fourth register 410) may be programmed to configure the corresponding bank (e.g., second bank 210, third bank 212, fourth bank 214) in the cache operation mode.

In some aspects, the cache controller 202 may be configured to control operation (e.g., power consumption) of hardware associated with implementing the tag array 216 based on the selected mode of operation (e.g., cache operation mode or non-cache operation mode) for the respective bank of the cache memory 204. For example, the hardware associated with implementing the tag array 216 for a respective bank of the cache memory 204 may be powered on while the respective bank of the cache memory 204 is configured in the cache operation mode. Alternatively, the hardware associated with implementing the tag array 216 for the respective bank of the cache memory 204 may be powered off while the respective bank of the cache memory 204 is configured in the non-cache operation mode since the tag array 216 for the respective bank of the cache memory 204 is bypassed in the non-cache operation mode. In this manner, by powering off hardware associated with implementing the tag array 216 for respective banks of the cache memory 204 configured in the non-cache operation mode, the cache controller 202 may improve (e.g., minimize) power consumption of the polymorphic system level cache 400.

### Example Register for Cache Controller of Polymorphic System Level Cache

FIG. 5 depicts a register 500 for a cache controller of a polymorphic system level cache according to some aspects of the present disclosure. For instance, the register 500 may be implemented for each of the registers 402 included in the cache controller 202 of the polymorphic system level cache 400 discussed above with reference to FIG. 4. As illustrated, the register 500 includes a flag 502, a bank range 504, a first logic circuit 506, and a second logic circuit 508.

In some aspects, the flag 502 may indicate an operation mode for a respective bank (e.g., Bank 0, Bank 1, Bank 2, or Bank 3) of the cache memory (e.g., cache memory 204). For instance, the flag 502 may be programmed (e.g., via software) to indicate whether the respective bank of the cache memory is configured to operate in the cache operation mode or the non-cache operation mode. For example, the flag 502 may be a single bit that may be set (e.g., via software) to a first value (e.g, 0) to indicate the respective bank of the cache memory is configured to operate in the cache operation mode or to a second value (e.g., 1) to indicate the respective bank of the cache memory is configured to operate in the non-cache operation mode.

In some aspects, the bank range 504 may indicate an address range for the respective bank of the cache memory. The address range for the respective bank of the cache memory may include a set of address that map to the respective bank of the cache memory based on a cache index scheme for the cache memory.

In some aspects, a request (e.g., request 220 received by the cache controller 202 of the polymorphic system level cache 400 of FIG. 4) may include an address 510. For instance, as illustrated in FIG. 5, the address 510 may be 32 bits long and may include a first portion 512 (e.g., labeled “range”) that indicates an address mapping to one of the respective banks of the cache memory. In some aspects, the first portion 512 of the address 510 may include the 18 most significant bits.

In some aspects, the address 510 may include a second portion 514 (e.g., labeled “index”) that represents a row index for the data that is being requested. For example, the row index may correspond to one of a plurality of cache lines included in the respective bank of the cache memory that is associated with the request. In some aspects, the row index may include the next 8 most significant bits occurring after the first portion 512 (e.g., 18 most significant bits) of the address 510.

In some aspects, the address 510 may include a third portion 516 (e.g., labeled “data op”) that represents which operation (e.g., read or write) is to be applied to the row (e.g., cache line) of the respective bank according to the row index (e.g., the second portion 514 of the address). In some aspects, the data op may include the next 6 most significant bits following the second portion 514 of the address 510.

In some aspects, the first logic circuit 506 may be configured to determine whether the first portion 512 (e.g., range) of the address 510 corresponds (e.g., matches) the bank range 504. For example, the first portion 512 of the address 510 may be provided as a first input to the first logic circuit 506. Additionally, the bank range 504 stored in the register 500 may be provided as a second input to the first logic circuit 506. The first logic circuit 506 may be configured to compare the first input and the second input to determine whether the first portion 512 of the address 510 matches the bank range 504 stored in the register 500.

In some aspects, an output 520 of the first logic circuit 506 may be based on the comparison of the first input (e.g., first portion 512 of address 510) and the second input (e.g., bank range 504). For example, if the first logic circuit 506 determines the first portion 512 of the address 510 matches the bank range 504, the output 520 of the first logic circuit 506 may be a first value (e.g., a logic value of “1”). Conversely, if the first logic circuit 506 determines the first portion 512 of the address does not match the bank range 504, the output 520 of the first logic circuit 506 may be a second value (e.g., a logic value of “0”) that is different from the first value (e.g., a logic value of “1”).

In some aspects, the second logic circuit 508 may be configured to generate an output 522 indicative of a selected operation mode (e.g., cache operation mode or non-cache operation mode) for the respective bank of the cache memory. For instance, the second logic circuit 508 may receive the flag 502 as a first input and the output 520 of the first logic circuit 506 as a second input. If the flag 502 and the output 520 of the first logic circuit 506 have the same logic value (e.g., a logic value of “1”), then the output 522 of the second logic circuit 508 may indicate that the non-cache operation mode is the selected operation mode for the respective bank of the cache memory. Alternatively, if the flag 502 and the output 520 of the first logic circuit 50 do not have the same logic value (or, both have a logic value of “0”), then the output 522 of the second logic circuit 508 may indicate that the cache operation mode is the selected operation mode for the respective bank of the cache memory.

Example Bank of Cache Memory Having a Local Register for Temporary Storage of Data

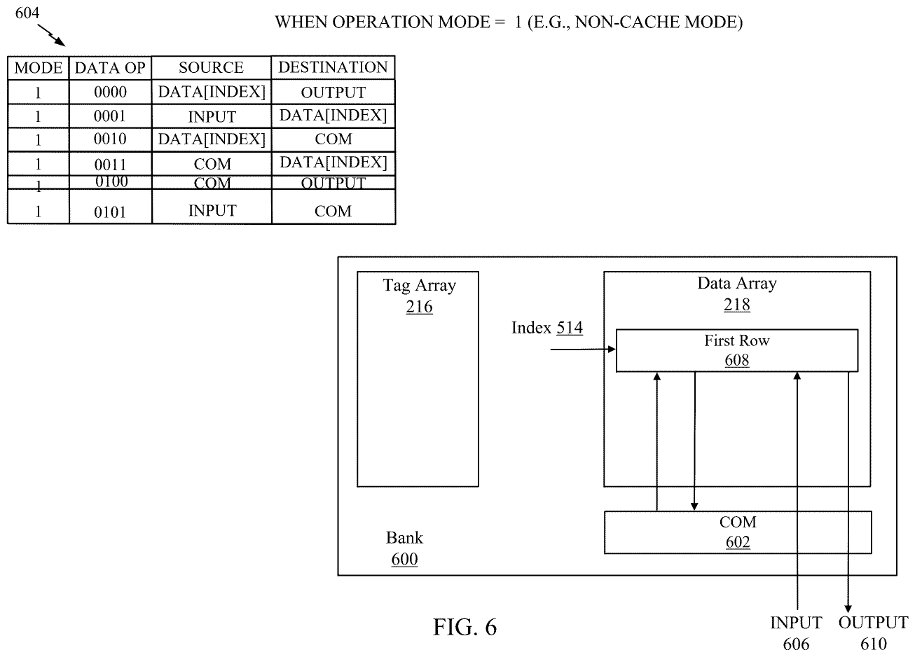

FIG. 6 depicts a block diagram of components of a bank 600 of cache memory according to some aspects of the present disclosure. As shown, the bank 600 of cache memory may include the same components as each of the different banks of the cache memory 204 of the polymorphic system level cache 400 discussed above with reference to FIG. 4. For example, the bank 600 of cache memory may include the tag array 216 and the data array 218. Accordingly, the same reference numbers may be used for those components the bank 600 of cache memory in FIG. 6 shares with each of the plurality of banks 206 of cache memory 204 of the polymorphic system level cache 400 depicted in FIG. 4.

The bank 600 of cache memory may include a local register 602 (e.g., labeled “COM”) that, in some aspects, is separate (e.g., in addition to) the data array 218. The local register 602 may be configured to store (e.g., temporarily) data when the bank 600 is configured to operate in the non-cache operation mode (e. g, output 522 of second logic circuit 508 in FIG. 5 has a logic value of 1). For instance, as indicated by table 604, the data operation (e.g., third portion 516 of address 510 in FIG. 5) may indicate whether the local register 602 is the source or destination for a particular data operation. In this manner, the local register 602 may provide temporary storage for data operations associated with requests (e.g., address 510 in FIG. 5) received while the bank 600 of the cache memory is configured in the non-cache operation mode. Accordingly, the bank 600 of the cache memory may eliminate the need for utilizing other memory (e.g, main memory 116 in FIG. 1) for temporary storage of data.

In some aspects, the data array 218 may be configured as the data array 300 discussed above with reference to FIG. 3, and the local register 602 may be communicatively coupled to one or more rows of the plurality of rows (e.g., cache lines) of memory elements (e.g., memory elements 302 in FIG. 3) included in the data array 300. In some aspects, the local register 602 may be included in one of the sense amplifiers (e.g., one of sense amplifiers 312 in FIG. 3) of the data array 300.

In some aspects, the local register 602 may be used to temporarily store data associated with a data operation involving the transfer of data between two processing units (e. g, CPU, GPU, NPU) of a system-on-chip having a system level cache that includes the bank 600 of cache memory. For example, input 606 may correspond to data that a first processing unit of the system-on-chip is requesting to write to the bank 600 of cache memory, specifically a first row 608 of the data array 218 thereof. Furthermore, the output 610 may correspond to data that is to be provided to a second processing unit of the system-on-chip.

### Example Bank of Cache Memory Having an Arithmetic Logic Unit (alu) Array for Local Vector Processing

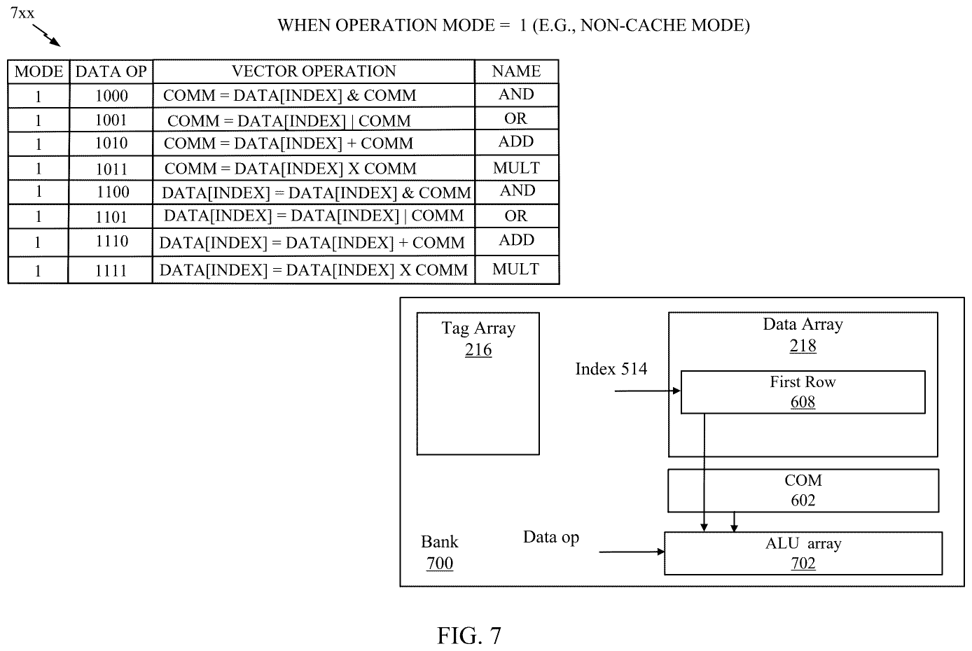

FIG. 7 depicts a block diagram of components of a bank 700 of cache memory according to some aspects of the present disclosure. As shown, the bank 700 of cache memory may include the same components as the bank 600 of cache memory discussed above with reference to FIG. 6. For example, the bank 700 of cache memory in FIG. 7 may include the tag array 216, the data array 218, and the local register 602. Accordingly, the same reference numbers may be used for those components the bank 700 of cache memory in FIG. 7 shares with the bank 600 of cache memory depicted in FIG. 6.

Conventional system-on-chips include arithmetic logic unit arrays. The arithmetic logic arrays are typically included as part of the individual processing units (e.g., processing units 102 of system-on-chip 100 in FIG. 1). Thus, data operations being performed on a respective bank of cache memory of conventional system-on-chips and involving vector processing are typically handled by one of the processing units. The latency associated with sending a request for vector processing and awaiting the result of such vector processing can be significant, especially in computationally intensive workloads, such as those associated with executing machine learning algorithms.

The bank 700 of cache memory in FIG. 7 includes an arithmetic logic unit array 702. For instance, the arithmetic logic unit array 702 may be located in proximity (e.g., next) to the local register 602 and may be configured to perform different vector operations (e.g., shown in table 704) while the bank 700 of cache memory is configured in the non-cache operation mode. The combination of the local register 602 (e.g., for temporary data storage) and the arithmetic logic unit array 702 (e.g., for vector computing) improves performance (e.g., more efficient utilization of computing resources) of system-on-chips, because the bank 700 cache memory eliminates the latency associated with conventional system-on-chips performing vector operations on data, such as data located in the system level cache.

### Example Method for Operating a Polymorphic System Level Cache

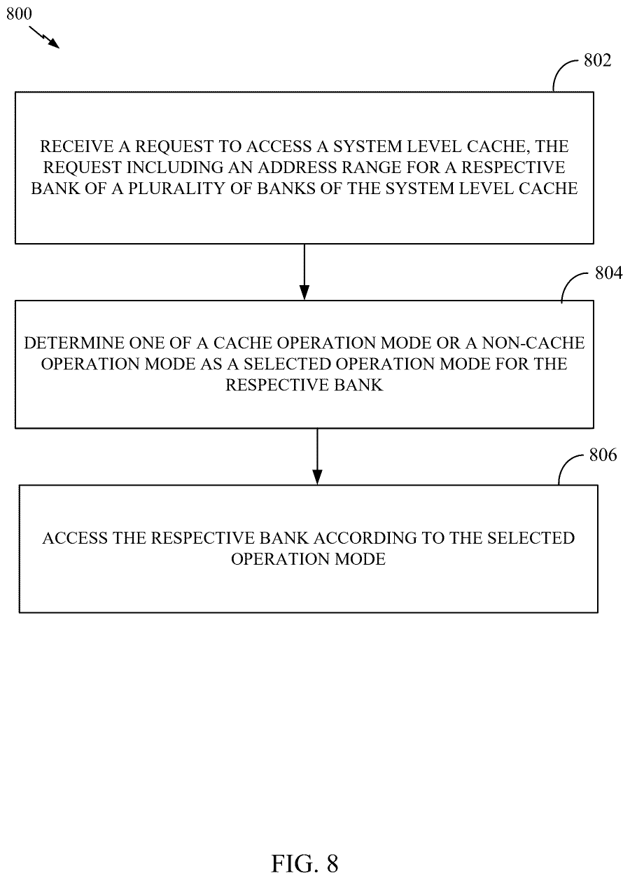

FIG. 8 depicts an example method 800 for operating a polymorphic system level cache according to some aspects of the present disclosure. For example, the method 800 may be performed by the cache controller 202 of FIG. 4. Furthermore, although FIG. 8 depicts steps performed in a particular order for purposes of illustration and discussion, the method 800 discussed herein is not intended to be limited to any particular order or arrangement. One skilled in the art, using the disclosure provided herein, will appreciate that various steps of the method 800 can be omitted, rearranged, combined and/or adapted in various ways without deviating from the scope of the present disclosure.

At 802, the method 800 includes receiving a request to access a system level cache. In some aspects, the request may include an address range corresponding to an address range for a respective bank of a plurality of banks of the cache memory. For example, the request may include an address (e.g., the address 510 of FIG. 5) and the address range may correspond to a portion (e.g., the first portion 512 of address 510 of FIG. 5). In certain aspects, the cache controller 202 may include a register (e.g., register 500 of FIG. 5) that is communicatively coupled to the respective bank of the cache memory and includes a logic circuit (e.g., first logic circuit 506 of FIG. 5) configured to determine whether the address range included in the request corresponds (e.g., matches) the address range that is stored in the register and indicative of the address range for the respective bank.

At 804, the method 800 includes determining a selected operation mode of the respective bank of the system level cache. For example, in some aspects, determining the selected operation mode may include reading a flag (e.g., flag 502) of the register that indicates whether the selected operation mode for the respective bank of the cache memory is the cache operation mode (e.g., in which the tag checking process is performed for each request) or the non-cache operation mode (e.g., in which the tag checking process is bypassed).

At 806, the method 800 includes accessing the respective bank of cache according to the selected operation mode. For instance, if the selected operation mode for the respective bank is the cache mode, data (e.g., index and data op) included in the request received at 802 may be provided to the tag array of the respective bank so that the tag array may perform the tag checking process to determine whether the request results in a cache hit or a cache miss. Alternatively, if the selected operation mode for the respective bank is the non-cache operation mode, data (e.g., index and data op) included in the request received at 802 may be directly provided to the data array of the respective bank.

### Example Method for Performing Local Vector Processing in a System Level Cache

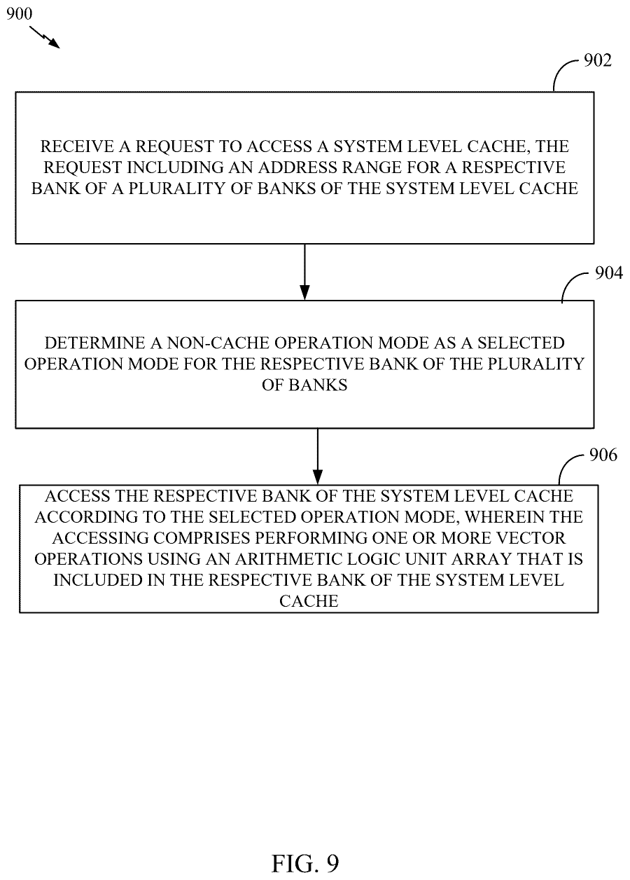

FIG. 9 depicts an example method 900 for performing local vector processing in a system level cache according to some aspects of the present disclosure. For example, the method 900 may be performed using the polymorphic system level cache 400 of FIG. 4 and the arithmetic logic unit array 702 of FIG. 7. Furthermore, although FIG. 9 depicts steps performed in a particular order for purposes of illustration and discussion, the method 800 discussed herein is not intended to be limited to any particular order or arrangement. One skilled in the art, using the disclosure provided herein, will appreciate that various steps of the method 900 can be omitted, rearranged, combined and/or adapted in various ways without deviating from the scope of the present disclosure.

At 902, the method 900 includes receiving a request to access the system level cache, the request including an address range corresponding to an address range for a respective bank of a plurality of banks of the system level cache. For example, in certain aspects, the request may include an address (e.g., the address 510 as illustrated in FIG. 5).

At 904, the method 900 includes determining a non-cache operation mode as a selected operation mode for the respective bank of the plurality of banks. For example, in certain aspects, determining the non-cache operation mode as the selected operation mode for the respective bank may include comparing (e.g., using a first logic circuit 506 as illustrated in FIG. 5) an address range (e.g., first portion 512 of address 510 as illustrated in FIG. 5) included in the request received at 902 to a bank range (e.g., bank range 504 as illustrated in FIG. 5) stored in a register (e.g., register 500 as illustrated in FIG. 5) to determine the address range included in the request corresponds (e.g., matches) the bank range stored in the register. Furthermore, determining the non-cache operation mode as the selected operation mode may further include comparing an output (e.g., a logic value) of a first logic circuit (e.g., logic circuit 506 as illustrated in FIG. 5) to a value (e.g., also a logic value) stored in the register and indicative of the operation mode (e.g., cache operation mode or non-cache operation mode) for the respective bank of the cache memory. For example, a second logic circuit (e.g., logic circuit 508 as illustrated in FIG. 5) may compare the output of the first logic circuit and the value stored in the register. If both inputs have the same logic value (e.g., a logic value of “1”), the second logic circuit may generate an output (e.g., output 522 as illustrated in FIG. 5) indicating the non-cache operation mode is the selected operation mode for the respective bank of the cache memory.

At 906, the method 900 includes accessing the respective bank of the system level cache according to the selected operation mode, wherein the accessing comprises performing one or more vector operations using an arithmetic logic unit array that is included in the respective bank of the system level cache.

### Example Processing System

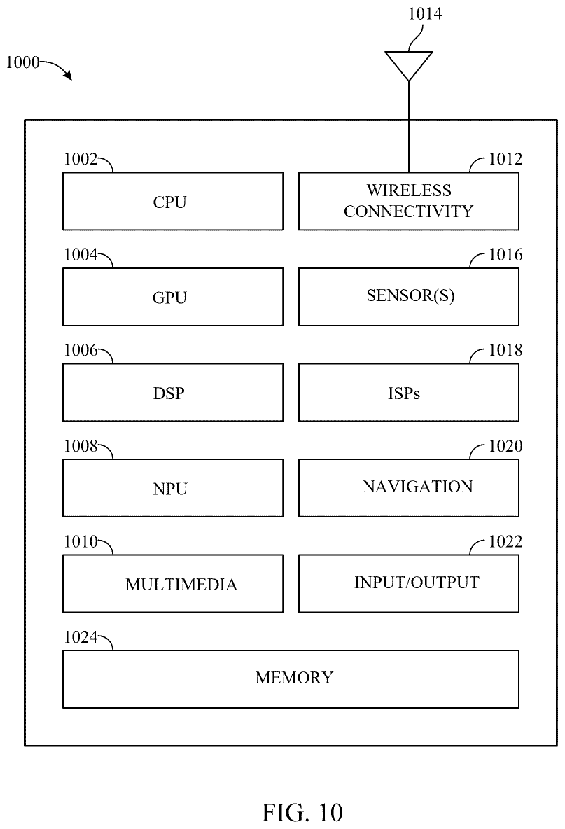

In some aspects, the polymorphic system level cache 400 of FIG. 4 may be implemented in a processing system. FIG. 10 depicts an example processing system 1400. Although depicted as a single system for conceptual clarity, in some aspects, as discussed above, the operations described below with respect to the processing system 1000 may be distributed across any number of devices or systems.

The processing system 1000 includes a central processing unit (CPU) 1002. Instructions executed at the CPU 1002 may be loaded, for example, from a memory 1024 associated with the CPU 1002.

The processing system 1000 also includes additional processing components tailored to specific functions, such as a graphics processing unit (GPU) 1004, a digital signal processor (DSP) 1006, a neural processing unit (NPU) 1008, a multimedia component 1010 (e.g., a multimedia processing unit), and a wireless connectivity component 1012.

An NPU, such as NPU 1008, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 1008, are configured to accelerate the performance of common machine learning tasks, such as image classification, machine translation, object detection, and various other predictive models. In some examples, a plurality of NPUs may be instantiated on a single chip, such as a SoC, while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 1008 is a part of one or more of the CPU 1002, the GPU 1004, and/or the DSP 1006.

In some examples, the wireless connectivity component 1012 may include subcomponents, for example, for third generation (3G) connectivity, fourth generation (4G) connectivity (e.g., 4G Long-Term Evolution (LTE)), fifth generation connectivity (e.g., 5G or New Radio (NR)), Wi-Fi connectivity, Bluetooth connectivity, and/or other wireless data transmission standards. The wireless connectivity component 1012 is further coupled to one or more antennas 1014.

The processing system 1000 may also include one or more sensor processing units 1016 associated with any manner of sensor, one or more image signal processors (ISPs) 1018 associated with any manner of image sensor, and/or a navigation processor 1020, which may include satellite-based positioning system components (e.g., GPS or GLONASS), as well as inertial positioning system components.

The processing system 1000 may also include one or more input and/or output devices 1022, such as screens, touch-sensitive surfaces (including touch-sensitive displays), physical buttons, speakers, microphones, and the like.

The processing system 1000 also includes the memory 1024, which is representative of one or more static and/or dynamic memories, such as a dynamic random access memory, a flash-based static memory, and the like. In this example, the memory 1024 includes computer-executable components, which may be executed by one or more of the aforementioned processors of the processing system 1000.

Generally, the processing system 1000 and/or components thereof may be configured to perform the methods described herein.

Notably, in other aspects, elements of the processing system 1000 may be omitted, such as where the processing system 1000 is a server computer or the like. For example, the multimedia component 1010, the wireless connectivity component 1012, the sensor processing units 1016, the ISPs 1018, and/or the navigation processor 1020 may be omitted in other aspects. Further, aspects of the processing system 1000 may be distributed between multiple devices.

### Example Clauses

In addition to the various aspects described above, specific combinations of aspects are within the scope of the disclosure, some of which are detailed below:

Aspect 1: An apparatus, comprising: a system level cache comprising a cache controller and plurality of banks, the cache controller configured to control operation of each of the plurality of banks, at least one bank of the plurality of banks comprising: a data array; a local register communicatively coupled to data array; and an arithmetic logic unit array communicatively coupled to the local register and the data array.

Aspect 2: The apparatus of Aspect 1, wherein the arithmetic logic unit array is configured to: receive first data stored in the data array; receive second data stored in the local register; receive third data indicative of a data opcode; and perform a vector operation involving the first data and the second data and based on the third data indicative of the data opcode.

Aspect 3: The apparatus of Aspect 1, wherein the data array comprises: a plurality of memory elements arranged in a row-column configuration; a plurality of bit lines; and a plurality of sense amplifiers, each of the plurality of sense amplifiers communicatively coupled to two respective bit lines of the plurality of bit lines.

Aspect 4: The apparatus of Aspect 3, wherein a first sense amplifier of the plurality of sense amplifiers includes the local register.

Aspect 5: The apparatus of Aspect 1, wherein the cache controller includes a plurality of registers, each of the plurality of registers configured to generate an output based, at least in part, on a memory request, the output indicating whether an operation mode for a respective bank of the plurality of banks is a cache operation mode or a non-cache operation mode.

Aspect 6: The apparatus of Aspect 5, wherein each of the plurality of registers is configured to store: first data indicating whether the non-cache operation mode is disabled or enabled for the respective bank of the system level cache; and second data indicating an address range for the respective bank of the system level cache.

Aspect 7: The apparatus of Aspect 6, wherein each of the plurality of registers further include: a logic circuit configured to determine the operation mode for the respective bank based, at least in part, on the memory request, the first data, and the second data.

Aspect 8: The apparatus of Aspect 5, wherein operation of the arithmetic logic unit array is controlled based on the operation mode for the at least one bank.

Aspect 9: The apparatus of Aspect 8, wherein the arithmetic logic unit array is operable when the output of the respective register indicates the operation mode for the at least one bank is the non-cache operation mode.

Aspect 10: The apparatus of Aspect 9, wherein: the at least one bank comprises a tag array; and when the operation mode for the at least one bank is the non-cache operation mode, the tag array is bypassed.

Aspect 11: A method performed by a system level cache included in a system-on-chip, comprising: receiving a request to access the system level cache, the request including an address range corresponding to an address range for a respective bank of a plurality of banks of the system level cache; determining a non-cache operation mode as a selected operation mode for the respective bank of the plurality of banks; and accessing the respective bank of the system level cache according to the selected operation mode, wherein the accessing comprises performing one or more vector operations using an arithmetic logic unit array that is included in the respective bank of the system level cache.

Aspect 12: The method of Aspect 11, wherein the performing comprises: receiving first data from a data array included in the respective bank; receiving second data from a local register included in the respective bank; receiving third data indicating a data opcode; and performing a vector operation involving the first data and the second data and based on the third data indicative of the data opcode.

Aspect 13: The method of Aspect 11, wherein the determining comprises reading a value stored in a register communicatively coupled to the respective bank of the plurality of banks.

Aspect 14: The method of Claim 13, wherein the register is included in a cache controller of the system level cache.

Aspect 15: The method of Aspect 11, wherein the respective bank of the plurality of banks includes a tag array and the method further comprises: controlling operation of hardware associated with the tag array based on the determining.

Aspect 16: The method of Aspect 15, wherein the controlling comprises powering off the hardware.

Aspect 17: The method of Aspect 11, wherein the request is associated with transferring data from a first processing unit of the system-on-chip to a second processing unit of the system-on-chip.

Aspect 18: The method of Aspect 17, wherein the data is associated with executing a machine learning algorithm.

Aspect 19: The method of Aspect 11, wherein the accessing further comprises bypassing a tag checking process and directly providing data associated with the request to the respective bank of the plurality of banks.

Aspect 20: An apparatus, comprising: means for receiving a request to access the system level cache, the request including an address range corresponding to an address range for a respective bank of a plurality of banks of the system level cache; means for determining a non-cache operation mode as a selected operation mode for the respective bank of the plurality of banks; and means for accessing the respective bank of the system level cache according to the selected operation mode, wherein the accessing comprises performing one or more vector operations using an arithmetic logic unit array that is included in the respective bank of the system level cache.

### Additional Considerations

The various operations of methods described above may be performed by any suitable means capable of performing the corresponding functions. The means may include various hardware and/or software components(s) module(s), including, but not limited to a circuit or processor. Generally, where there are operations illustrated in figures, those operations may have corresponding counterpart means-plus-function components with similar numbering.

For example, means for receiving a request to access a system level cache may include a cache controller (e.g., cache controller 202 as illustrated in FIG. 4). Means for determining a non-cache operation mode as a selected operation mode for the respective bank of the system level cache may include a register (e.g., one of registers 402 as illustrated in FIG. 4). Means for accessing the respective bank of the system level cache according to the selected operation mode, wherein the accessing comprises performing one or more vector operations using an arithmetic logic unit array that is included in the respective bank of the system level cache may include the cache controller and the arithmetic logic unit array (e.g., arithmetic logic unit array 702 as illustrated in FIG. 7).

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus, comprising:
a system level cache comprising a cache controller and plurality of banks, the cache controller configured to control operation of each of the plurality of banks, at least one bank of the plurality of banks comprising:
a data array;
a local register communicatively coupled to data array; and
an arithmetic logic unit array communicatively coupled to the local register and the data array.

2. The apparatus of claim 1, wherein the arithmetic logic unit array is configured to:
receive first data stored in the data array;
receive second data stored in the local register;
receive third data indicative of a data opcode; and
perform a vector operation involving the first data and the second data and based on the third data indicative of the data opcode.

3. The apparatus of claim 1, wherein the data array comprises:
a plurality of memory elements arranged in a row-column configuration;
a plurality of bit lines; and
a plurality of sense amplifiers, each of the plurality of sense amplifiers communicatively coupled to two respective bit lines of the plurality of bit lines.

4. The apparatus of claim 3, wherein a first sense amplifier of the plurality of sense amplifiers includes the local register.

5. The apparatus of claim 1, wherein the cache controller includes a plurality of registers, each of the plurality of registers configured to generate an output based, at least in part, on a memory request, the output indicating whether an operation mode for a respective bank of the plurality of banks is a cache operation mode or a non-cache operation mode.

6. The apparatus of claim 5, wherein each of the plurality of registers is configured to store:
first data indicating whether the non-cache operation mode is disabled or enabled for the respective bank of the system level cache; and
second data indicating an address range for the respective bank of the system level cache.

7. The apparatus of claim 6, wherein each of the plurality of registers further include:
a logic circuit configured to determine the operation mode for the respective bank based, at least in part, on the memory request, the first data, and the second data.

8. The apparatus of claim 5, wherein operation of the arithmetic logic unit array is controlled based on the operation mode for the at least one bank.

9. The apparatus of claim 8, wherein the arithmetic logic unit array is operable when the output of the respective register indicates the operation mode for the at least one bank is the non-cache operation mode.

10. The apparatus of claim 9, wherein:
the at least one bank comprises a tag array; and
when the operation mode for the at least one bank is the non-cache operation mode, the tag array is bypassed.

11. A method performed by a system level cache included in a system-on-chip, comprising:
receiving a request to access the system level cache, the request including an address range corresponding to an address range for a respective bank of a plurality of banks of the system level cache;
determining a non-cache operation mode as a selected operation mode for the respective bank of the plurality of banks; and
accessing the respective bank of the system level cache according to the selected operation mode, wherein the accessing comprises performing one or more vector operations using an arithmetic logic unit array that is included in the respective bank of the system level cache.

12. The method of claim 11, wherein the performing comprises:
receiving first data from a data array included in the respective bank;
receiving second data from a local register included in the respective bank;
receiving third data indicating a data opcode; and
performing a vector operation involving the first data and the second data and based on the third data indicative of the data opcode.

13. The method of claim 11, wherein the determining comprises reading a value stored in a register communicatively coupled to the respective bank of the plurality of banks.

14. The method of claim 13, wherein the register is included in a cache controller of the system level cache.

15. The method of claim 11, wherein the respective bank of the plurality of banks includes a tag array and the method further comprises:
controlling operation of hardware associated with the tag array based on the determining.

16. The method of claim 15, wherein the controlling comprises powering off the hardware.

17. The method of claim 11, wherein the request is associated with transferring data from a first processing unit of the system-on-chip to a second processing unit of the system-on-chip.

18. The method of claim 17, wherein the data is associated with executing a machine learning algorithm.

19. The method of claim 11, wherein the accessing further comprises bypassing a tag checking process and directly providing data associated with the request to the respective bank of the plurality of banks.

20. An apparatus, comprising:
means for receiving a request to access a system level cache, the request including an address range corresponding to an address range for a respective bank of a plurality of banks of the system level cache;
means for determining a non-cache operation mode as a selected operation mode for the respective bank of the plurality of banks; and
means for accessing the respective bank of the system level cache according to the selected operation mode, wherein the accessing comprises performing one or more vector operations using an arithmetic logic unit array that is included in the respective bank of the system level cache.
